(19) United States
(12) Patent Application Publication
(10) Pub. No.: US 2026/0045564 A1
(43) Pub. Date: Feb. 12, 2026

(54) ENERGY STORAGE APPARATUS

(71) Applicant: GS Yuasa International Ltd., Kyoto-shi (JP)

(72) Inventors: Kazuya OKABE, Kyoto-shi (JP); Ryoichi OKUYAMA, Kyoto-shi (JP)

(21) Appl. No.: 19/360,046

(22) Filed: Oct. 16, 2025

Related U.S. Application Data
(63) Continuation of application No. PCT/JP2024/004291, filed on Feb. 8, 2024.

(30) Foreign Application Priority Data
Apr. 18, 2023 (JP) 2023-068056

(51) Int. Cl. H01M 10/42; H01M 50/531; H01M 50/569; H02J 7/00

(52) U.S. Cl. CPC H01M 10/425; H01M 50/531; H01M 50/569; H02J 7/0014; H02J 7/007182; H01M 2010/4271

(57) ABSTRACT

An energy storage apparatus includes a plurality of electrode units stacked in a stacking direction and each including at least a current collector foil, a positive electrode active material layer on a first surface of the current collector foil, and a negative electrode active material layer on a second surface of the current collector foil, and a current collector foil included in one electrode unit of the plurality of electrode units includes a plurality of connecting portions electrically connected to a balancer circuit.

### CROSS REFERENCE TO RELATED APPLICATIONS

This application claims the benefit of priority to Japanese Patent Application No. 2023-068056 filed on Apr. 18, 2023 and is a Continuation Application of PCT Application No. PCT/JP2024/004291 filed on Feb. 8, 2024. The entire contents of each application are hereby incorporated herein by reference.

### BACKGROUND OF THE INVENTION

### 1. Field of the Invention

The present invention relates to energy storage apparatuses.

### 2. Description of the Related Art

JP 2012-54152 A discloses a bipolar secondary battery including a power generation element in which a plurality of unit cell layers are stacked by stacking bipolar electrodes each having a positive electrode active material layer on a first surface of a current collector and a negative electrode active material layer on a second surface of the current collector.

### SUMMARY OF THE INVENTION

Being able to improve reliability of an energy storage apparatus having a structure similar to that of the bipolar secondary battery disclosed in JP 2012-54152 A is desirable.

Example embodiments of the present invention provide energy storage apparatuses each with improved reliability.

An energy storage apparatus according to an example embodiment of the present invention pertains to an energy storage apparatus including a plurality of electrode units stacked in a stacking direction, in which each of the plurality of electrode units includes at least a current collector foil, a positive electrode active material layer on a first surface of the current collector foil, and a negative electrode active material layer on a second surface of the current collector foil, and a current collector foil included in one electrode unit of the plurality of electrode units includes a plurality of connecting portions electrically connected to a balancer circuit.

According to energy storage apparatuses of example embodiments of the present invention, the reliability thereof is improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram illustrating a schematic configuration of an energy storage apparatus according to an example embodiment of the present invention.

FIG. 2 is a perspective view illustrating an outer appearance of a unit group provided in an energy storage apparatus according to an example embodiment of the present invention.

FIG. 3 is a cross-sectional view illustrating an internal configuration of a unit group according to an example embodiment of the present invention.

FIGS. 4A and 4B are a perspective view and a cross-sectional view illustrating a configuration of an electrode unit included in a unit group according to an example embodiment of the present invention.

FIG. 5 is a schematic diagram illustrating a schematic configuration of an energy storage apparatus according to Modification Example 1 of an example embodiment of the present invention.

FIG. 6 is a schematic diagram illustrating a schematic configuration of an energy storage apparatus according to Modification Example 2 of an example embodiment of the present invention.

FIG. 7 is a side view illustrating positions of arrangement of connecting portions and connectors in a unit group according to Modification Example 3 of an example embodiment of the present invention.

FIG. 8 is a perspective view illustrating a configuration in which a connector is arranged for connecting portions of a unit group according to Modification Example 4 of an example embodiment of the present invention.

FIG. 9 is a cross-sectional view illustrating a configuration of an energy storage pack.

FIG. 10 is a cross-sectional view illustrating another configuration of the energy storage pack.

### DETAILED DESCRIPTION OF THE EXAMPLE EMBODIMENTS

(1) An energy storage apparatus according to an example embodiment of the present invention pertains to an energy storage apparatus including a plurality of electrode units stacked in a stacking direction, in which each of the plurality of electrode units includes at least a current collector foil, a positive electrode active material layer on a first surface of the current collector foil, and a negative electrode active material layer on a second surface of the current collector foil, and a current collector foil included in one electrode unit of the plurality of electrode units includes a plurality of connecting portions electrically connected to a balancer circuit.

According to this configuration, in the energy storage apparatus, the current collector foil of the electrode unit includes a plurality of connecting portions electrically connected to the balancer circuit. Accordingly, even if the current collector foil is large in size, balance control (equalization of the voltage) can be effectively performed, and thus, charge unevenness can be reduced or prevented. Since the current collector foil includes a plurality of connecting portions, even if a trouble occurs on one connecting portion side, balance control can be continued on an other connecting portion side. Thus, the reliability of the energy storage apparatus can be improved.

(2) The energy storage apparatus according to (1) described above may further include the balancer circuit including both a voltage measurement function and a resistance discharge function for the each of the plurality of electrode units, a first controller configured or programmed to use voltage information measured by the balancer circuit to acquire resistance discharge control information for the balancer circuit to perform resistance discharge, and a second controller configured or programmed to communicate with the first controller to exchange the voltage information and the resistance discharge control information.

According to this configuration, the energy storage apparatus includes the balancer circuit including both the voltage measurement function and the resistance discharge function for the each of the plurality of electrode units, the first controller, and the second controller configured or programmed to communicate with the first controller to exchange the voltage information of the balancer circuit and the resistance discharge control information. As the balancer circuit includes the voltage measurement function in addition to the resistance discharge function, and the second controller is configured or programmed to communicate information of the balancer circuit with the first controller, the first controller can issue a discharge instruction or the like to the balancer circuit. By this feature, even if the first controller is not located near the electrode unit or the balancer circuit, routing of a wiring line which is connected to the electrode unit can be reduced. By reducing the routing of the wiring line, it is possible to reduce the possibility of a short circuit or a disconnection which may occur during manufacturing of the energy storage apparatus or when the energy storage apparatus is being used, and reduce or prevent the possibility that sparks may be generated. By virtue of these features, the reliability of the energy storage apparatus can be improved.

(3) In the energy storage apparatus according to (2) described above, the plurality of connecting portions may be located on different sides of the current collector foil, and the first controller may be configured or programmed to perform control of a charge end according to a voltage information of a balancer circuit indicating a highest voltage in the one electrode unit at a time of charge control.

According to this configuration, in the energy storage apparatus, since the plurality of connecting portions are located on the different sides of the current collector foil, it is possible to locate the plurality of connecting portions on the current collector foil in relatively good balance. Thus, it is possible to reduce or prevent charge unevenness. Further, at the time of the charge control, the first controller is configured or programmed to perform the control of the charge end according to the voltage information of the balancer circuit indicating the highest voltage. By this feature, even when there is occurrence of charge unevenness, the first controller can be configured or programmed to perform the control on the basis of a more appropriate voltage at the time of the charge control.

(4) In the energy storage apparatus according to (2) or (3) described above, the plurality of connecting portions may be located on different sides of the current collector foil, and the first controller may be configured or programmed to perform control of a discharge end according to a voltage information of a balancer circuit indicating a lowest voltage in one electrode unit at a time of discharge control.

According to this configuration, in the energy storage apparatus, since the plurality of connecting portions are located on the different sides of the current collector foil, it is possible to locate the plurality of connecting portions on the current collector foil in relatively good balance. Thus, it is possible to reduce or prevent charge unevenness. Further, at the time of the discharge control, the first controller is configured or programmed to perform the control of the discharge end according to the voltage information of the balancer circuit indicating the lowest voltage. By this feature, even when there is occurrence of charge unevenness, the first controller is configured or programmed to perform the control on the basis of a more appropriate voltage at the time of the discharge control.

(5) In the energy storage apparatus according to (3) or (4) described above, the plurality of connecting portions may be located on sides of the current collector foil that are opposed to each other.

According to this configuration, in the energy storage apparatus, as the plurality of connecting portions are located on the sides of the current collector foil that are opposed to each other, the balancer circuit can be connected at a position where a voltage difference due to the charge unevenness is large. Therefore, the charge unevenness can be further reduced or prevented.

(6) In the energy storage apparatus according to any one of (2) to (5) described above, the balancer circuit and the second controller may be accommodated in a single control box, and may be separated from the plurality of electrode units.

If the control box in which the balancer circuit and the second controller are accommodated is located to be in contact with the electrode units, the electrode units may be affected by discharge heat generation of the balancer circuit, which may cause a decrease in the life performance of the electrode units. Therefore, the control box is separated from the electrode units. By this feature, thermal influence exerted on the electrode unit can be reduced or prevented.

(7) In the energy storage apparatus according to any one of (1) to (6) described above, an other current collector foil included in an other electrode unit of the plurality of electrode units may include an other connecting portion electrically connected to the balancer circuit, the energy storage apparatus may further include a plurality of connectors connected to the plurality of connecting portions, and an other connector connected to the other connecting portion, and a connection portion of each of the plurality of connectors, the connection portion being connected to the each of the plurality of connecting portions and a connection portion of the other connector, the connection portion being connected to the other connecting portion may be located at positions that do not overlap when viewed in the stacking direction.

According to this configuration, in the energy storage apparatus, the connection portion of each of the plurality of connectors connected to the each of the plurality of connecting portions, and the connection portion of the other connector connected to the other connecting portion, are located at positions that do not overlap when viewed in the stacking direction. By this feature, even in a case where the connection portion of the connector or the connection portion of the other connector has a large width in the stacking direction, it is possible to prevent those connection portions of the connector and the other connector from interfering with each other in the stacking direction.

(8) In the energy storage apparatus according to any one of (1) to (7) described above, an other current collector foil included in an other electrode unit of the plurality of electrode units may include an other connecting portion electrically connected to the balancer circuit, and the energy storage apparatus may further include a connector connected to at least one connecting portion of the plurality of connecting portions and the other connecting portion.

According to this configuration, since the energy storage apparatus is provided with the connector that is connected to the connecting portion and the other connecting portion, the balancer circuit can be easily connected to the connecting portion and the other connecting portion by way of a simple operation which is to connect the balancer circuit to the connector.

The following describes energy storage apparatuses according to example embodiments of the present invention (including modification examples thereof) with reference to the drawings. Each of the example embodiments described below illustrates either a comprehensive example or a specific example. A numerical value, a shape, a material, an element, a position of arrangement and a form of connection of the elements, manufacturing processes, an order of the manufacturing processes, and the like, which are described in the following example embodiments, are merely examples, and are not intended to limit the present invention. In each of the drawings, dimensions and the like are not strictly illustrated. In the drawings, same or similar elements are assigned an identical reference numeral.

In the following description and the drawings, when a unit group has a rectangular parallelepiped shape, a longitudinal direction of the unit group, or in other words, a direction in which a pair of short side surfaces of the unit group are opposed to each other, or a direction in which a pair of short sides of a surface of a current collector foil are opposed to each other, is defined as an X-axis direction. When the unit group has a rectangular parallelepiped shape, a direction in which a pair of long side surfaces of the unit group are opposed to each other, or in other words, a direction in which a pair of long sides of the surface of the current collector foil are opposed to each other, is defined as a Y-axis direction. When the surface of the current collector foil is square, one direction of the sets of directions that are opposed to each other is assumed as the X-axis direction, and an other direction intersecting the X-axis direction is assumed as the Y-axis direction. When the unit group does not have a rectangular parallelepiped shape or a cubic shape, a direction in which an end-to-end length of the surface of the current collector foil becomes the longest is defined as the X-axis direction, and a direction in which the end-to-end length of the surface of the current collector foil becomes the shortest is defined as the Y-axis direction. A thickness direction of the unit group, or in other words, a stacking direction of a plurality of electrode units, a stacking direction of the current collector foil and an active material layer, an arrangement direction of a pair of end members, or an up-down direction, is defined as a Z-axis direction. The X-axis direction, the Y-axis direction, and the Z-axis direction are directions intersecting each other (orthogonal to each other in the present example embodiment). Although there may be a case where the Z-axis direction does not conform to the up-down direction depending on a use mode, the Z-axis direction is described as the up-down direction in the following for convenience of description. In describing the configuration of the energy storage apparatus, the X-axis direction and the Y-axis direction are defined for convenience. However, the positions of individual members may be reversed in terms of the positions in the X-axis direction and the Y-axis direction. Also for the matters described by defining the directions in the X-axis direction and the Y-axis direction apart from the positions of the members, the X-axis direction and the Y-axis direction may be interchanged.

In the following description, an X-axis positive direction indicates a direction of an arrow in the X-axis, and an X-axis negative direction indicates a direction opposite to the X-axis positive direction. When the direction is simply referred to as the X-axis direction, it indicates both of or one of the X-axis positive direction and the X-axis negative direction. The same applies to the Y-axis direction and the Z-axis direction. Expressions indicating relative directions or postures, such as parallel and orthogonal, include cases where the directions or postures are not parallel or orthogonal in a strict sense. Two directions being parallel to each other means not only that the two directions are completely parallel to each other, but also that the two directions are substantially parallel to each other, in other words, a difference by several percent or so, for example, is included in the scope. In the following description, when the expression “insulating” is used, “insulating” is intended as “electrical insulation”.

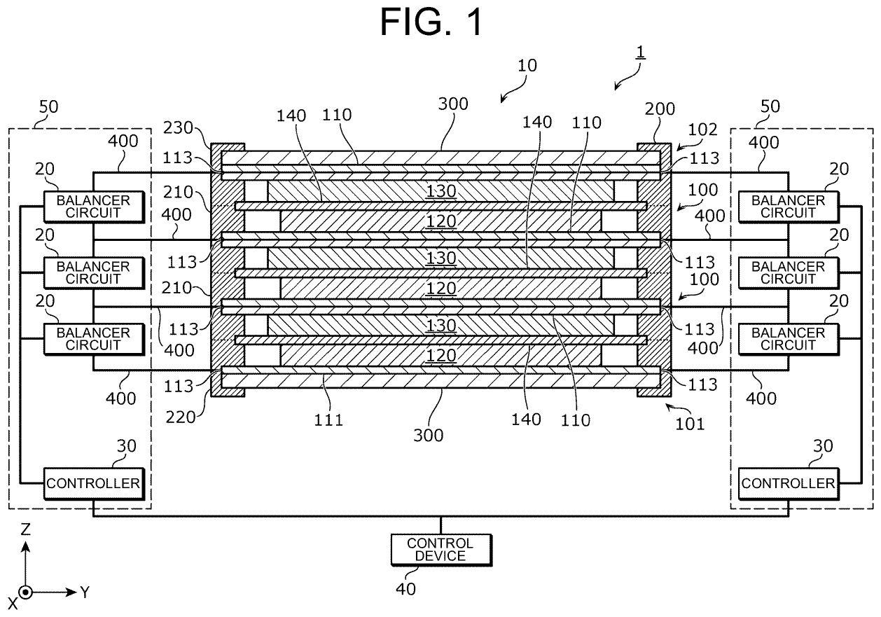

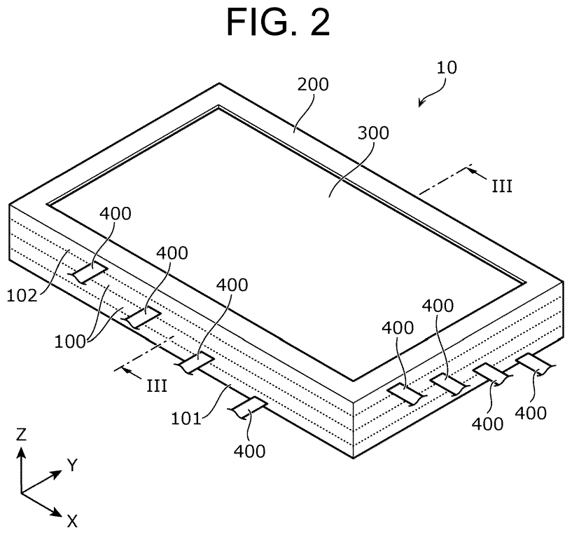

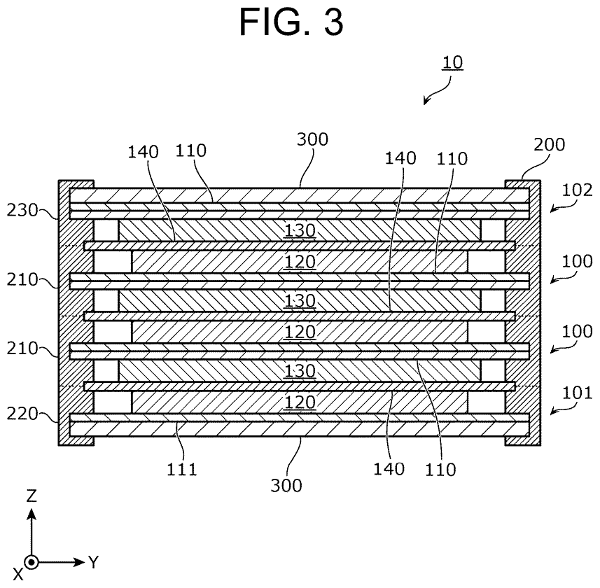

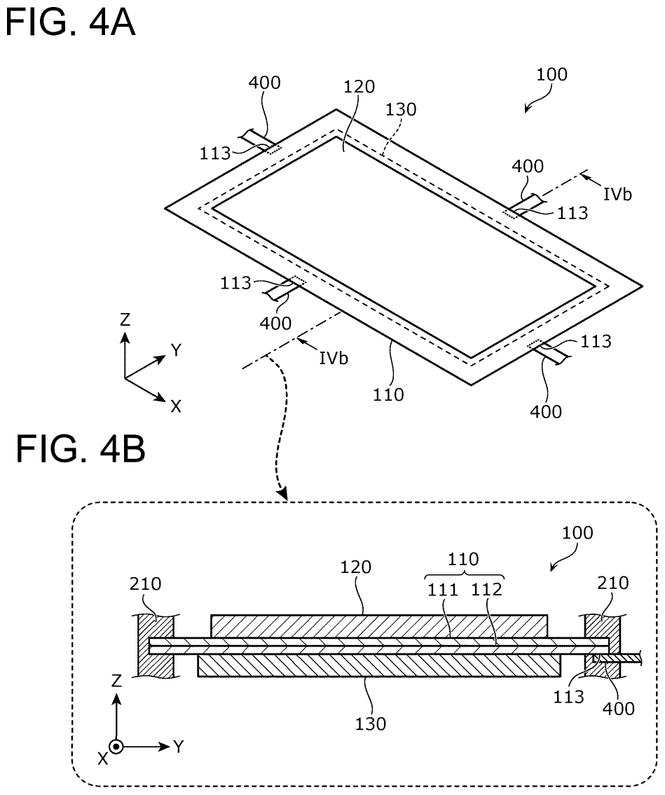

First, an energy storage apparatus 1 in the present example embodiment will be described. FIG. 1 is a schematic diagram illustrating a schematic configuration of the energy storage apparatus 1 according to the present example embodiment. FIG. 2 is a perspective view illustrating an outer appearance of a unit group 10 provided in the energy storage apparatus 1 according to the present example embodiment. FIG. 2 illustrates a configuration in which a connector 400 is connected to the unit group 10. FIG. 3 is a cross-sectional view illustrating an internal configuration of the unit group 10 according to the present example embodiment. Specifically, FIG. 3 is a cross-sectional view of the unit group 10 of FIG. 2 taken along a YZ plane passing through line III-III. FIG. 3 illustrates each of the elements provided in the unit group 10. FIGS. 4A and 4B are a perspective view and a cross-sectional view illustrating a configuration of an electrode unit 100 included in the unit group 10 according to the present example embodiment. Specifically, FIG. 4A is a perspective view illustrating an outer appearance of the electrode unit 100 and the connector 400. FIG. 4A shows the state in which the connector 400 is connected to the electrode unit 100 in a Z-axis positive direction, and a sealing portion 210 of the electrode unit 100 is omitted from the illustration. FIG. 4B is a cross-sectional view illustrating a configuration of the electrode unit 100 and the connector 400 in FIG. 4A taken along a YZ plane passing through line IVb-IVb. In FIG. 4B, the sealing portion 210 is also shown.

The energy storage apparatus 1 is an apparatus which can be charged with electricity from outside and can discharge electricity to the outside. The energy storage apparatus 1 is used as a battery for driving or starting an engine of movable bodies such as automobiles, motorcycles, watercrafts, ships, snowmobiles, agricultural machines, construction machines, automatic guided vehicles (AGV) or railway vehicles for electric railway. As the above-mentioned automobiles, electric vehicles (EVs), hybrid electric vehicles (HEVs), plug-in hybrid electric vehicles (PHEVs), and fossil fuel (gasoline, light oil, liquefied natural gas, or the like) automobiles are exemplified. As the above-mentioned railway vehicles for electric railway, trains, monorails, linear induction motor trains, and hybrid trains provided with both a diesel engine and an electric motor are exemplified. The energy storage apparatus 1 can also be used as a stationary battery or the like for home or business, etc.

As illustrated in FIG. 1, the energy storage apparatus 1 is provided with the unit group 10, the connector 400, a balancer circuit 20, a controller 30, and a control device 40. The unit group 10 and the balancer circuit 20 are connected to each other by the connector 400. The balancer circuit 20 is connected to the controller 30 by a wiring line. The controller 30 is connected to the control device 40 by a wiring line (a communication line). First, a configuration of the unit group 10 will be described in detail.

As illustrated in FIGS. 1 to 3, the unit group 10 of the present example embodiment has a substantially rectangular parallelepiped shape. Specifically, the unit group 10 is a bipolar battery. The unit group 10 includes a plurality of electrode units 100, end units 101 and 102, a plurality of separators 140, and a pair of end members 300. The electrode unit 100, the end unit 101, and the end unit 102 are each a plate-shaped portion having a rectangular shape in a plan view, and are stacked in the Z-axis direction. The plan view in the present example embodiment refers to a view in which the above elements are seen in the stacking direction (the Z-axis direction). A direction (the Z-axis direction) in which the plurality of electrode units 100, the end unit 101, and the end unit 102 are stacked is also referred to as the stacking direction. The separator 140 is located between the electrode units 100, between the electrode unit 100 and the end unit 101, and between the electrode unit 100 and the end unit 102. The pair of end members 300 are located on an outer side of the end units 101 and 102 in the stacking direction (the Z-axis direction). In the present example embodiment, although two electrode units 100 are stacked in the stacking direction between the end unit 101 and the end unit 102, the number of electrode units 100 to be stacked is not particularly limited. The shapes of the electrode unit 100, the end unit 101, and the end unit 102, etc., in a plan view are not particularly limited, and may be a polygonal shape, a circular shape, a partially curved shape, or the like.

In the following, a configuration of the electrode unit 100 will be described in detail also with reference to FIGS. 4A and 4B. The electrode unit 100 is a single unit in which an active material layer is formed on both sides of one sheet of current collector foil. Each of the plurality of electrode units 100 includes at least a current collector foil 110, a positive electrode active material layer 120 formed on a first surface of the current collector foil 110, a negative electrode active material layer 130 formed on a second surface of the current collector foil 110, and the sealing portion 210. In the present example embodiment, a thickness (thickness in the stacking direction) of the electrode unit 100 is about 135 μm to about 190 μm, for example.

The current collector foil 110 is a plate-shaped member having a rectangular shape in a plan view. The current collector foil 110 is a metal foil. As illustrated in FIGS. 4A and 4B, the current collector foil 110 includes two metal layers 111 and 112 arranged in the stacking direction (the Z-axis direction). Although the current collector foil 110 also includes a connecting portion 113 to which the connector 400 is connected, detailed description thereof will be given later. The metal layers 111 and 112 are plate-shaped portions having the same size and the same shape in a plan view. In the following, of the metal layers 111 and 112, the metal layer 111 on which the positive electrode active material layer 120 is formed will also be referred to as a positive electrode metal layer 111, and the metal layer 112 on which the negative electrode active material layer 130 is formed will also be referred to as a negative electrode metal layer 112. The positive electrode metal layer 111 is the metal layer which is located in the Z-axis positive direction of the current collector foil 110, and the negative electrode metal layer 112 is the metal layer which is located in a Z-axis negative direction of the current collector foil 110. The current collector foil 110 is formed by stacking the positive electrode metal layer 111 and the negative electrode metal layer 112 in the stacking direction in a state in which the positive electrode metal layer 111 and the negative electrode metal layer 112 are connected to each other (brought into contact with each other or bonded to each other). Of the positive electrode metal layer 111 and the negative electrode metal layer 112, one of these metal layers may be a metal foil, and an other one of the metal layers may be a plating layer plated on the metal foil. Alternatively, both the positive electrode metal layer 111 and the negative electrode metal layer 112 may be metal foils. When both of the positive electrode metal layer 111 and the negative electrode metal layer 112 are metal foils, the current collector foil 110 may be a clad material or the like formed by bonding two metal foils to each other, or alternatively, include two metal foils in a state in which the two metal foils are connected to (brought into contact with) each other without being bonded.

As a material of the positive electrode metal layer 111, a metal such as aluminum, titanium, tantalum, or stainless steel, or an alloy thereof is used. Among the above materials, aluminum or an aluminum alloy is preferable as the material of the positive electrode metal layer 111 in view of a balance among potential resistance, high conductivity, and the cost. As a form of the positive electrode metal layer 111, while a plating layer may be used, foil is preferable in terms of processability and the cost. Aluminum foil is preferable as the positive electrode metal layer 111. As a material of the negative electrode metal layer 112, a metal such as copper, nickel, stainless steel, or nickel-plated steel, or an alloy thereof is used, and among these materials, copper or a copper alloy should be preferably used. As the form of the negative electrode metal layer 112, a plating layer or a foil (copper foil) is given as an example, and examples of the copper foil include rolled copper foil and electrolytic copper foil. The thickness (thickness in the stacking direction) of the current collector foil 110 is about 20 μm to about 30 μm, for example. The thickness (thickness in the stacking direction) of the positive electrode metal layer 111 is about 5 μm to about 20 μm, and the thickness (thickness in the stacking direction) of the negative electrode metal layer 112 is about 5 μm to about 15 μm, for example.

The positive electrode active material layer 120 is an active material layer of a positive electrode formed on a first surface (a surface in the Z-axis positive direction) of the current collector foil 110. Specifically, the positive electrode active material layer 120 is formed on the positive electrode metal layer 111 (i.e., an outer surface (the surface in the Z-axis positive direction) of the positive electrode metal layer 111). The positive electrode active material layer 120 is smaller in size than the positive electrode metal layer 111 in a plan view, and is formed in a rectangular shape in the present example embodiment. Being small in size in a plan view means that an area of an XY plane is small. The same can be said of the following. The shape of the positive electrode active material layer 120 in a plan view may be a polygonal shape, a circular shape, a partially curved shape, or the like. In a plan view, the positive electrode metal layer 111 and the positive electrode active material layer 120 have the same or similar shapes. The thickness (thickness in the stacking direction) of the positive electrode active material layer 120 is about 70 μm to about 100 μm, for example.

The positive electrode active material layer 120 contains a positive electrode active material, and if necessary, contains optional components such as a conductive agent, a binder, a thickener, and a filler. Examples of the positive electrode active material include layered lithium transition metal oxides such as LiM1O₂ (where M1 is one or more metallic elements selected from a group consisting of Li, Fe, Ni, Mn, Co, and the like), spinel-type lithium transition metal oxides such as LiM2₂O₄ (where M2 is one or more metallic elements selected from a group consisting of Li, Fe, Ni, Mn, Co, and the like), and polyanion compounds such as LiM3PO₄, LiM3SiO₄, and LiM3BO₃ (where M3 is one or more metallic elements selected from a group consisting of Li, Fe, Ni, Mn, Co, and the like). As the positive electrode active material, one of these compounds may be used alone, or two or more of these compounds may be mixed and used. The conductive agent contained in the positive electrode active material layer 120 is not particularly limited as long as conductivity is exhibited. Examples of the conductive agent include carbon black, such as furnace black, acetylene black, and ketjen black, and natural or artificial graphite. Examples of the binder (a binding agent) include fluororesins (polytetrafluoroethylene (PTFE), polyvinylidene fluoride (PVDF), and the like), sulfonated EPDM, and styrene-butadiene rubber (SBR). Examples of the thickener include polysaccharide polymers such as carboxymethyl cellulose (CMC) and methyl cellulose.

The negative electrode active material layer 130 is an active material layer of a negative electrode formed on a second surface (a surface in the Z-axis negative direction) of the current collector foil 110. Specifically, the negative electrode active material layer 130 is formed on the negative electrode metal layer 112 (i.e., an outer surface (the surface in the Z-axis negative direction) of the negative electrode metal layer 112). The negative electrode active material layer 130 is smaller in size than the negative electrode metal layer 112 in a plan view, and is formed in a rectangular shape in the present example embodiment. The negative electrode active material layer 130 is formed to be larger in size than the positive electrode active material layer 120 in a plan view. Being large in size in a plan view means that an area of the XY plane is large. The same can be said of the following. The area of the XY plane of the negative electrode active material layer 130 is larger than that of the positive electrode active material layer 120. The shape of the negative electrode active material layer 130 in a plan view may be a polygonal shape, a circular shape, a partially curved shape, or the like. In a plan view, the negative electrode metal layer 112 and the negative electrode active material layer 130 have the same or similar shapes. The thickness (thickness in the stacking direction) of the negative electrode active material layer 130 is about 45 μm to about 60 μm, for example.

The negative electrode active material layer 130 contains a negative electrode active material, and if necessary, contains optional components such as a conductive agent, a binder, a thickener, and a filler. As the optional components such as the conductive agent, the binder, the thickener, and the filler, components similar to those of the positive electrode active material layer 120 may be used. As the negative electrode active material, a material capable of occluding and releasing lithium ions is usually used. Examples of the negative electrode active material include metals or semimetals such as Si and Sn; metal oxides or semimetal oxides such as Si oxides and Sn oxides; and carbon materials such as graphite and non-graphite carbon (easily-graphitizable carbon or non-graphitizable carbon).

The sealing portion 210 is a portion located around the positive electrode active material layer 120 or the negative electrode active material layer 130. In the present example embodiment, the sealing portion 210 is an annular portion located around the positive electrode active material layer 120 and the negative electrode active material layer 130 over the entire periphery of the positive electrode active material layer 120 and the negative electrode active material layer 130 when viewed in the Z-axis direction. Specifically, the sealing portion 210 is formed in a square annular shape along an outer peripheral portion of the current collector foil 110 so as to cover the outer peripheral portion of the current collector foil 110. The sealing portion 210 is formed of an insulating member constituted of polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), or ABS resin, or a composite material thereof.

The sealing portions 210 of two adjacently arranged electrode units 100 are connected to each other. The sealing portions 210 may be integrally and continuously formed to be connected to each other, or the sealing portions 210 may be bonded to each other by heat sealing (thermal welding), ultrasonic welding, laser welding, or an adhesive, etc., to be connected to each other. Thus, the sealing portion 210 is located around the positive electrode active material layer 120 of one electrode unit 100 of the two electrode units 100 and the negative electrode active material layer 130 of the other one of the two electrode units 100, and the sealing portion 210 is provided between the current collector foils 110 of these two electrode units 100. The sealing portion 210 is continuously provided between the current collector foils 110 of the two electrode units 100, and space between the current collector foils 110 is sealed.

An electrolyte layer (not shown) is formed on an inner side of the sealing portion 210 of each of the plurality of electrode units 100. In the present example embodiment, while the electrolyte layer is a nonaqueous liquid electrolyte (electrolytic solution), the electrolyte layer may be a solid-form electrolyte (solid electrolyte), a gel electrolyte, or the like. As these electrolytes, known electrolytes can be used as appropriate. As the electrolytic solution (nonaqueous electrolyte), an electrolytic solution formed by dissolving an electrolyte salt in a nonaqueous solvent may be used. Examples of the nonaqueous solvent include cyclic carbonates such as ethylene carbonate (EC) and propylene carbonate (PC), and chain carbonates such as diethyl carbonate (DEC), dimethyl carbonate (DMC), and ethyl methyl carbonate (EMC). As the electrolyte salt, a lithium salt is preferable. Examples of the lithium salt mentioned above include inorganic lithium salts such as LiPF₆, LiPO₂F₂, LiBF₄, LiClO₄, LiN(SO₂F)₂, and LiN(SO₂CF₃).

Next, a configuration of the end units 101 and 102 will be described in detail. The end unit 101 is located closer to an end portion in the Z-axis negative direction than the plurality of electrode units 100. The end unit 102 is located closer to an end portion in the Z-axis positive direction than the plurality of electrode units 100. The end units 101 and 102 are portions which sandwich the plurality of electrode units 100 in the Z-axis direction.

The end unit 101 includes at least the positive electrode metal layer 111, the positive electrode active material layer 120 formed on a surface of the positive electrode metal layer 111 in the Z-axis positive direction, and a sealing portion 220. The positive electrode metal layer 111 and the positive electrode active material layer 120 included in the end unit 101 have configurations similar to those of the positive electrode metal layer 111 and the positive electrode active material layer 120 of the current collector foil 110 included in the electrode unit 100 described above.

The sealing portion 220 is a portion located around the positive electrode active material layer 120. In the present example embodiment, the sealing portion 220 is an annular portion located around the positive electrode active material layer 120 over the entire periphery of the positive electrode active material layer 120 when viewed in the Z-axis direction. Specifically, the sealing portion 220 is formed in a square annular shape along an outer peripheral portion of the positive electrode metal layer 111 and the end member 300 so as to cover the outer peripheral portion of the positive electrode metal layer 111 and the end member 300 in the X-axis direction and the Y-axis direction. The sealing portion 220 is made of the same material as that of the sealing portion 210.

The sealing portion 220 and the sealing portion 210 which is adjacent to the sealing portion 220 are connected to each other. The aforementioned sealing portion 210 is included in the electrode unit 100 which is adjacent to the end unit 101. Since the connection of the sealing portion 220 and the sealing portion 210 is the same as the above-described connection of the sealing portions 210 to each other, detailed description thereof will be omitted. Thus, space between the positive electrode metal layer 111 of the end unit 101 and the current collector foil 110 of the electrode unit 100 is sealed by the sealing portion 210 and the sealing portion 220. The electrolyte layer described above (not shown) is formed on the inner side of the sealing portion 220.

The end unit 102 includes at least the current collector foil 110, the negative electrode active material layer 130 located on a surface of the current collector foil 110 in the Z-axis negative direction, and a sealing portion 230. The configurations of the current collector foil 110 and the negative electrode active material layer 130 of the end unit 102 are the same as those of the current collector foil 110 and the negative electrode active material layer 130 included in the electrode unit 100 described above.

The sealing portion 230 is a portion located around the negative electrode active material layer 130. In the present example embodiment, the sealing portion 230 is an annular portion located around the negative electrode active material layer 130 over the entire periphery of the negative electrode active material layer 130 when viewed in the Z-axis direction. Specifically, the sealing portion 230 is formed in a square annular shape along an outer peripheral portion of the current collector foil 110 and the end member 300 so as to cover the outer peripheral portion of the current collector foil 110 and the end member 300 in the X-axis direction and the Y-axis direction. The sealing portion 230 is made of the same material as that of the sealing portion 210.

The sealing portion 230 and the sealing portion 210 which is adjacent to the sealing portion 230 are connected to each other. The aforementioned sealing portion 210 is included in the electrode unit 100 which is adjacent to the end unit 102. Since the connection of the sealing portion 230 and the sealing portion 210 is the same as the above-described connection of the sealing portions 210 to each other, detailed description thereof will be omitted. Thus, space between the current collector foil 110 of the end unit 102 and the current collector foil 110 of the electrode unit 100 is sealed by the sealing portion 210 and the sealing portion 230. The electrolyte layer described above (not shown) is formed on the inner side of the sealing portion 230.

In this way, the sealing portion 210 and the sealing portion 210, the sealing portion 210 and the sealing portion 220, and the sealing portion 210 and the sealing portion 230 are connected to each other to constitute a sealing member 200. The sealing member 200 is a tubular (quadrangular tubular) member which is located so as to surround the entire periphery of the positive electrode metal layer 111, the negative electrode metal layer 112, the positive electrode active material layer 120, the negative electrode active material layer 130, the separator 140, and the end member 300 in the X-axis direction and the Y-axis direction, and seals between these elements and the outside.

The separator 140 is a microporous sheet made of resin. The separator 140 is located between the electrode units 100, between the end unit 101 and the electrode unit 100, and between the end unit 102 and the electrode unit 100. Specifically, the separator 140 is located between the positive electrode active material layer 120 and the negative electrode active material layer 130. As a material of the separator 140, woven fabric, nonwoven fabric, a porous resin film, or the like, is used. Among the above materials, a porous resin film is preferable. As the main component of the porous resin film, polyolefins such as polyethylene and polypropylene are preferable from the standpoint of the strength. The separator 140 may be a multilayered film including layers containing fillers formed on the surfaces of such porous resin films. The separator 140 is formed in a rectangular shape that is larger in size than the negative electrode active material layer 130 in a plan view. In the present example embodiment, although the size of the separator 140 is smaller than that of the current collector foil 110 in a plan view, the separator 140 may be larger in size than the current collector foil 110 in a plan view. The thickness (thickness in the stacking direction) of the separator 140 is about 15 μm to about 20 μm, for example.

The end member 300 is a member located closer to an end portion of the unit group 10 in the stacking direction (the Z-axis direction) than the plurality of electrode units 100. In the present example embodiment, the paired end members 300 are located at the farthest end portion in the Z-axis negative direction of the unit group 10 and the farthest end portion in the Z-axis positive direction of the same, respectively. The paired end members 300 are each connected to (the positive electrode metal layer 111 included in) the end units 101 and 102. Thus, the paired end members 300 sandwich the plurality of electrode units 100 and the end units 101 and 102, and the like, which are positioned between the end members 300 from both sides in the stacking direction (the Z-axis direction). The end member 300 is a flat-shaped member (an end plate). The end member 300 is electrically connected to another end member 300 of another unit group 10 via another conductive member (a bus bar or a cooling plate, etc., not illustrated). The end member 300 is formed of a conductive member made of metal such as aluminum, an aluminum alloy, copper, a copper alloy, or nickel, or a combination thereof, or a member having conductivity other than metal, for example. Since the end member 300 is connected to the positive electrode metal layer 111, the end member 300 should preferably be formed of the same material as that of the positive electrode metal layer 111 such as aluminum. The thickness (thickness in the stacking direction) of the end member 300 is about 0.5 mm to about 3 mm, for example. The unit group 10 may include another conductive member on an outer side of the end member 300 (i.e., on the outer side in the Z-axis direction).

In the above-described configuration, the separator 140, the positive electrode active material layer 120 and the negative electrode active material layer 130 sandwiching the separator 140 in the Z-axis direction, and the positive electrode metal layer 111 and the negative electrode metal layer 112 sandwiching the aforementioned elements in the Z-axis direction may be referred to as one energy storage device. In this case, it can also be said that the unit group 10 is a group of energy storage devices having a configuration in which a plurality of energy storage devices stacked in the Z-axis direction are sandwiched between the pair of end members 300 in the Z-axis direction, and a periphery of these elements is surrounded by the sealing member 200.

Next, the connecting portion 113 of the current collector foil 110 and the connector 400 will be described. As illustrated in FIGS. 4A and 4B, the current collector foil 110 includes the connecting portion 113 which is connected to the connector 400. The connecting portion 113 is a portion of the current collector foil 110 to which the connector 400 is connected by contact, and is located at an end portion of the current collector foil 110.

The current collector foil 110 includes a plurality of connecting portions 113. The plurality of connecting portions 113 are located at different sides (edges) of the current collector foil 110. The plurality of connecting portions 113 are located on sides (edges) of the current collector foil 110 that are opposed to each other. The plurality of connecting portions 113 are located such that the connecting portion 113 is located on a side different from the sides of the other connecting portions 113 of the current collector foil 110. Specifically, each of the plurality of connecting portions 113 is located on an edge different from the edges of the other connecting portions 113 of the current collector foil 110. Further, the plurality of connecting portions 113 are located on any one side of the current collector foil 110 and a side opposed to that side. Specifically, the plurality of connecting portions 113 are located on any one edge of the current collector foil 110 and an edge opposed to that edge. The plurality of connecting portions 113 are located at positions which match when rotated by 180° about an axis (virtual axis) parallel to the Z-axis direction passing through a center of the current collector foil 110 (i.e., rotationally symmetric positions or positions symmetrical about a point with respect to the center). In the present example embodiment, one connecting portion 113 is located on each of the four edges of the current collector foil 110 (i.e., four connection portions 113 are located in total). In the current collector foil 110, the connecting portions 113 are located on an X-axis positive direction side (the edge in the X-axis positive direction), an X-axis negative direction side (the edge in the X-axis negative direction), a Y-axis positive direction side (the edge in the Y-axis positive direction), and a Y-axis negative direction side (the edge in the Y-axis negative direction), respectively.

In the present example embodiment, the connecting portion 113 is located on a surface of the current collector foil 110 in the Z-axis negative direction, and the connector 400 is connected to the above-mentioned surface of the current collector foil 110 in the Z-axis negative direction. Since the connecting portion 113 is located within the sealing portion 210 together with the end portion of the current collector foil 110, a distal end portion of the connector 400 is located within the sealing portion 210 in a state of being connected to the connecting portion 113. The connector 400 is connected to the connecting portion 113 in a state in which the distal end portion thereof is inserted into the sealing portion 210. In this way, the connector 400 is connected to the current collector foil 110 in a state in which the connector 400 is covered with the current collector foil 110 from the Z-axis positive direction side.

The connector 400 is a wiring line connected to the balancer circuit 20. In the present example embodiment, the connector 400 is a plate-like wiring line having a reduced thickness in the Z-axis direction. Specifically, the connector 400 is a part of a flexible circuit board (not illustrated). A plurality of connectors 400 are unified to constitute one piece of flexible circuit board, and each of distal end parts of the connectors 400 is extended in a separated manner and is connected to the connecting portion 113. The number of connectors 400 which constitute one piece of flexible circuit board is not particularly limited. The shape of the connector 400 is also not particularly limited, and the connector 400 may be an electric wire or the like, instead of being a part of the flexible circuit board.

As described above, the current collector foil 110 included in one electrode unit 100 (the electrode unit 100 in the Z-axis positive direction) of the plurality of electrode units 100 is provided with a plurality of connecting portions 113 which are electrically connected to the balancer circuit 20. Similarly, an other current collector foil 110 included in an other electrode unit 100 (the electrode unit 100 in the Z-axis negative direction) of the plurality of electrode units 100 is provided with an other connecting portion 113 which is electrically connected to the balancer circuit 20. Thus, the energy storage apparatus 1 includes a plurality of connectors 400 connected to the plurality of connecting portions 113, and an other connector 400 connected to the other connecting portion 113. All of the current collector foils 110 included in every one of the electrode units 100 are provided with a plurality of connecting portions 113 which are electrically connected to the balancer circuit 20, and the connectors 400 are located and connected to the respective connecting portions 113. Similarly, the current collector foil 110 included in the end unit 102 and the positive electrode metal layer 111 provided in the end unit 101 are also provided with a plurality of connecting portions 113 which are electrically connected to the balancer circuit 20, and the connectors 400 are located and connected to the respective connecting portions 113.

As illustrated in FIG. 2, the distal end part of the connector 400 which is connected to the electrode unit 100 in the Z-axis positive direction, and the distal end part of the connector 400 (the other connector 400 mentioned above) which is connected to the electrode unit 100 in the Z-axis negative direction are located at positions that do not overlap one another when viewed in the Z-axis direction (stacking direction). The connecting portion 113 provided in the current collector foil 110 of the electrode unit 100 in the Z-axis positive direction, and the connecting portion 113 (the other connecting portion 113 mentioned above) provided in the current collector foil 110 of the electrode unit 100 in the Z-axis negative direction are located at positions that do not overlap one another when viewed in the Z-axis direction. Specifically, in the connecting portions 113 located on the edge of each of the current collector foils 110 in the X-axis positive direction and the connecting portions 113 located on the edge of each of the current collector foils 110 in the X-axis negative direction, the connecting portion 113 is located at a position different from that of the other connecting portion 113 mentioned above in the Y-axis direction. As regards the connecting portions 113 located on the edge of each of the current collector foils 110 in the Y-axis positive direction and the connecting portions 113 located on the edge of each of the current collector foils 110 in the Y-axis negative direction, the connecting portion 113 is located at a position different from that of the other connecting portion 113 mentioned above in the X-axis direction.

Thus, connection portions, which are portions connected to a plurality of connecting portions 113, of a plurality of connectors 400 that are connected to the plurality of connecting portions 113 of the electrode unit 100 in the Z-axis positive direction, and connection portions, which are portions connected to a plurality of connecting portions 113 (the other connecting portions 113), of a plurality of connectors 400 (the other connectors 400) that are connected to the plurality of connecting portions 113 of the electrode unit 100 in the Z-axis negative direction are located at positions that do not overlap one another when viewed in the Z-axis direction (stacking direction). The connection portion that is connected to the connecting portion 113 of the connector 400, which is connected to the electrode unit 100 in the Z-axis positive direction via the connecting portion 113, and the connection portion that is connected to the connecting portion 113 (the other connecting portion 113) of the connector 400 (the other connector 400), which is connected to the electrode unit 100 in the Z-axis negative direction via the connecting portion 113 (the other connecting portion 113) are located at positions that do not overlap one another when viewed in the Z-axis direction (stacking direction). The same applies to the connection portion that is connected to the connecting portion 113 of the connector 400, which is connected to the current collector foil 110 of the end unit 102 via the connecting portion 113, and the connection portion that is connected to the connecting portion 113 of the connector 400, which is connected to the positive electrode metal layer 111 of the end unit 101 via the connecting portion 113. All of the connecting portions 113 are located at positions not overlapping with the other connecting portions 113 when viewed in the Z-axis direction. Accordingly, in all of the connectors 400, the connection portion that is connected to the connecting portion 113 is located at a position that does not overlap with the other connection portions when viewed in the Z-axis direction.

Next, the balancer circuit 20, the controller 30, and the control device 40 illustrated in FIG. 1 will be described. The balancer circuit 20, the controller 30, and the control device 40 are devices (electronic components, circuits, or the like) configured as separate units different from each other.

The balancer circuit 20 is a circuit (an element) having both a voltage measurement function and a resistance discharge function for each of the plurality of electrode units 100. The balancer circuit 20 includes a circuit (an element) capable of measuring a voltage of the electrode unit 100, a resistor for discharging electric power of the electrode unit 100, and a relay which switches the discharge to be on or off. The balancer circuit 20 measures the voltage of the electrode unit 100 and sends (communicates) the measured voltage information to the control device 40 via the controller 30. The balancer circuit 20 switches, in response to an instruction based on resistance discharge control information from the control device 40 via the controller 30, the relay to be on or off and performs discharge control by resistance, and adjusts (equalizes) the states of charge (voltages) between the electrode units 100. The resistance discharge control information is information acquired as the control device 40 performs arithmetic processing on the voltage information. As the balancer circuit 20, a conventionally known balancer circuit may be used as appropriate.

In the present example embodiment, a plurality of balancer circuits 20 are connected to a single electrode unit 100. Specifically, four balancer circuits 20 are connected to a single electrode unit 100. Four balancer circuits 20 are respectively connected to four connecting portions 113 provided on the current collector foil 110 of a single electrode unit 100 illustrated in FIGS. 4A and 4B via four connectors 400. The connection is not limited to that in which four balancer circuits 20 are connected to the four connecting portions 113. That is, two or three connecting portions 113 among the four connecting portions 113 may be connected to one balancer circuit 20. Two or three balancer circuits 20 may be connected to the four connecting portions 113. Preferably, the balancer circuit 20 should be located near the connecting portion 113 to which the balancer circuit 20 is connected.

As illustrated in FIG. 1, each of the balancer circuits 20 is connected to two electrode units 100 which are adjacent to each other in the Z-axis direction, and adjusts (equalizes) the states of charge (voltages) between the two electrode units 100. Alternatively, the balancer circuit 20 is connected to the electrode unit 100 and the end unit 102 which are adjacent to each other in the Z-axis direction, or the electrode unit 100 and the end unit 101 which are adjacent to each other in the Z-axis direction, and adjusts (equalizes) the states of charge (voltages) of the aforementioned elements. The electrode unit 100 in the Z-axis positive direction is connected to two balancer circuits 20, which are the balancer circuit 20 that is connected to the electrode unit 100 in the Z-axis negative direction, and the balancer circuit 20 that is connected to the end unit 102. Therefore, the connector 400, which is connected to the two balancer circuits 20, is connected to one connecting portion 113 provided on the current collector foil 110 of the electrode unit 100 in the Z-axis positive direction. The same applies to the electrode unit 100 in the Z-axis negative direction.

The controller 30 is a device (an electronic component, a circuit, or the like) which communicates with the control device 40 to exchange the voltage information of the balancer circuit 20 and the resistance discharge control information. The controller 30 transmits the voltage information on the electrode unit 100 which has been measured by the balancer circuit 20 to the control device 40. The controller 30 controls the resistance discharge by the balancer circuit 20 on the basis of an instruction from the control device 40. More specifically, the control device 40 acquires the resistance discharge control information by arithmetically processing the voltage information. The control device 40 gives an instruction based on the resistance discharge control information to the controller 30. Information transmission between the controller 30 and the control device 40 is performed by electrical connection using a communication line (a control line). Therefore, the controller 30 plays a role of sending (communicating) the voltage information acquired from the balancer circuit 20 to the control device 40, and a role of sending (communicating) the resistance discharge control information acquired from the control device 40 to the balancer circuit 20. When the voltage information is sent (communicated) from the controller 30 to the control device 40, the voltage information is converted into a communications language and conveyed to the control device 40. The controller 30 converts the voltage of the electrode unit 100 which has been measured by the balancer circuit 20 into a voltage signal, and transmits the converted voltage signal to the control device 40 as the voltage information. Therefore, the controller 30 can convey the voltage information to the control device 40 at a voltage lower than that of a case where the voltage information is not converted into a communications language (a voltage signal). The controller 30 does not have an arithmetic function, and operates on the basis of an instruction from the control device 40.

The energy storage apparatus 1 includes a plurality of controllers 30, and one controller 30 is provided for a plurality of balancer circuits 20. In FIG. 1, although one controller 30 is provided for three balancer circuits 20, one controller 30 may be provided for any number of balancer circuits 20. It is preferable that one controller 30 should be provided for a plurality of balancer circuits 20 which are close to each other in distance. As described above, the controller 30 is integrated with a plurality of electrode units 100 such that the controller 30 can communicate with the control device 40 to exchange the voltage information on the plurality of electrode units 100 and the resistance discharge control information. The controller 30 is provided with a switch for switching a target of control to a desired balancer circuit 20 that is provided among the plurality of electrode units 100, and the target is switched to the balancer circuit 20 to be controlled on the basis of an instruction from the control device 40, thereby controlling the target balancer circuit 20.

The balancer circuits 20 and the controller 30 are accommodated in a single control box 50. A plurality of (three in FIG. 1) balancer circuits 20 and one controller 30 are accommodated in a single control box 50. The energy storage apparatus 1 is provided with a plurality of control boxes 50 for a plurality of controllers 30. The control box 50 is a box-shaped case made of resin or metal, etc. In the present example embodiment, the control box 50 is located to be separated from the plurality of electrode units 100 (the unit group 10). The control box 50 is separated from the unit group 10 by arranging a resin plate, a metal plate, a heat-insulating porous member (glass paper, a ceramic plate, or the like), or a space, etc., between the unit group 10 and the control box 50.

The control device 40 is a device having an arithmetic function. The energy storage apparatus 1 is provided with one control device 40 for a plurality of controllers 30 (control boxes 50). In the present example embodiment, the control device 40 is a battery management unit (BMU) which monitors and controls the state of each of the electrode units 100. The place where the control device 40 is installed is not particularly limited. However, in the present example embodiment, the control device 40 is installed at a place distant from the unit group 10 and the control boxes 50 (the balancer circuits 20 and the controllers 30). The control device 40 acquires the above-described voltage information and the like from the controller 30 via the communication line, and calculates data (resistance discharge control information and the like) necessary for adjusting (equalizing) the states of charge (voltages) between the electrode units 100. The control device 40 conveys, on the basis of the calculated data (the resistance discharge control information and the like), a discharge start instruction and a discharge end instruction, etc., to the controller 30 via the communication line. In this way, the control device 40 uses the voltage information measured by the balancer circuit 20 to arithmetically calculate and acquire the resistance discharge control information for the balancer circuit 20 to perform the resistance discharge.

An instruction path among the balancer circuit 20, the controller 30, and the control device 40 will be specifically described. At a start of discharge of the balancer circuit, the control device 40 gives an instruction for the balancer discharge on the basis of the voltage information from each of the balancer circuits 20. That is, the control device 40 gives, to the balancer circuit 20 which has reached a prescribed voltage at which the balancer discharge should be performed, an instruction to start the balancer discharge by a signal. When the discharge is to be stopped, the control device 40 gives an instruction to stop the balancer discharge when a voltage from each of the balancer circuits 20 reaches a prescribed voltage or at the time when a discharge of the energy storage apparatus 1 has been finished. The control device 40 also determines charge end control and discharge end control of the energy storage apparatus 1. In the charge end control of the energy storage apparatus 1, the control device 40 gives an instruction to end the charge on the basis of the highest voltage in one electrode unit 100. At the time of the discharge end control of the energy storage apparatus 1, the control device 40 gives a discharge end instruction on the basis of the lowest voltage in one electrode unit 100. These voltages are acquired by the balancer circuit 20 connected to the target electrode unit 100, converted into voltage signals by the controller 30, and then transmitted to the control device 40 via the controller 30. In this way, the control device 40 acquires the resistance discharge control information indicating the contents of control which is to perform: (i) control of a charge end according to the voltage information (a voltage signal) of the balancer circuit 20 indicating the highest voltage in one electrode unit 100 at the time of charge control, and (ii) control of a discharge end according to the voltage information (the voltage signal) of the balancer circuit 20 indicating the lowest voltage in one electrode unit 100 at the time of discharge control. The control device 40 performs the above kinds of control (i) and (ii) on the basis of the resistance discharge control information. The control device 40 performs control (such as stopping the charge) at a charge end stage of the energy storage apparatus 1 on the basis of the highest voltage from among those of the balancer circuits 20 of the energy storage apparatus 1 as a whole. The control device 40 performs control (such as stopping the discharge) at a discharge end stage of the energy storage apparatus 1 as a whole on the basis of the lowest voltage from among those of the balancer circuits 20 of the energy storage apparatus 1 as a whole.

As described above, in the energy storage apparatus 1 according to the present example embodiment of the present invention, the current collector foil 110 of the electrode unit 100 includes a plurality of connecting portions 113 which are electrically connected to the balancer circuit 20. Accordingly, even if the current collector foil 110 is large in size, balance control (equalization of the voltage) can be effectively performed, and thus, charge unevenness can be reduced or prevented. In particular, in a bipolar battery, since the voltage is varied in one electrode unit 100, the effect obtained by being able to suppress the charge unevenness in one electrode unit 100 is high. Further, discharge unevenness which occurs due to the charge unevenness can also be reduced or prevented. Since the current collector foil 110 includes the plurality of connecting portions 113, even if a trouble occurs on the side of one connecting portion 113, balance control can be continued on the side of the other connecting portions 113. Since a plurality of balancer circuits 20 are arranged to correspond to the plurality of connecting portions 113, even if one balancer circuit 20 breaks down, a normal balancer circuit 20 remains. Therefore, as the control device 40 receives the voltage signal and an abnormality signal (an abnormality flag), the control device 40 can continue the control based on voltage measurement by the normal balancer circuit 20, and can be normally operated until the energy storage apparatus 1 or an energy storage pack 2 to be described later, for example, including the broken-down balancer circuit 20 is replaced. Thus, reliability of the energy storage apparatus 1 can be improved.

The bipolar secondary battery disclosed in JP 2012-54152 A indicated above is configured such that a plurality of voltage detection wiring lines are branched from a plurality of discharge wiring lines and connected to a control circuit. For this reason, although a plurality of wiring lines to which voltages are applied need to be routed, it is undesirable to perform routing of the wiring lines to which voltages are applied. If a wiring line is routed, the possibility that a short circuit or a disconnection may be caused increases during manufacturing of a bipolar secondary battery or when the bipolar secondary battery is being used. A voltage of the battery is applied to a wiring line for voltage measurement. Therefore, when a short circuit occurs, a large current flows, which may cause the wiring line to be disconnected or may become a source of sparks generation. Since routing of voltage lines is conducted by bundling thin voltage lines or using a flexible circuit board, when the wiring line is fused, it is possible that surrounding wiring lines may also be fused.

In contrast, the energy storage apparatus 1 includes: the balancer circuit 20 having both the voltage measurement function and the resistance discharge function for each of the plurality of electrode units 100; the control device 40; and the controller 30 which communicates with the control device 40 to exchange the voltage information of the balancer circuit 20 and the resistance discharge control information. As the balancer circuit 20 has the voltage measurement function in addition to the resistance discharge function, and the controller 30 communicates information of the balancer circuit 20 to the control device 40, the control device 40 can issue a discharge instruction or the like to the balancer circuit 20. By this feature, even if the control device 40 is not located near the electrode unit 100 or the balancer circuit 20, it is possible to reduce the length required to route a thin (weak) wiring line having a voltage that is connected to the electrode unit 100. By reducing the routing length of the thin (weak) wiring line having a voltage, and using a strong communication line to communicate the information of the balancer circuit 20 to the control device 40, it is possible to reduce the possibility of occurrence of a short circuit or a disconnection of the thin (weak) wiring line having a voltage, and to suppress generation of sparks when the short circuit or disconnection occurs. By virtue of these features, reliability of the energy storage apparatus 1 can be improved.

Specifically, the features are as described below. Since a voltage is applied to the wiring line connected to the electrode unit 100, if a plurality of wiring lines are routed, a short circuit may occur during manufacturing of the energy storage apparatus 1 or when the energy storage apparatus 1 is being used. For this reason, voltage measurement is performed near the electrode unit 100 by the balancer circuit 20, and the controller 30 communicates the information of the balancer circuit 20 to the control device 40. Accordingly, it is possible to reduce the routing of the wiring line connected to the electrode unit 100, whereby the possibility of occurrence of a short circuit can be reduced. Since the thickness of the wiring line having a voltage (the wiring line directly connected to the electrode unit 100) is small, the strength thereof is low. Thus, there is a possibility of the short circuit and disconnection. When a short circuit and a disconnection occur, since the voltage is high, the risk that sparks may be generated is high. The communication line is thicker than the aforementioned wiring line, and thus, the strength of the communication line is high and a short circuit and a disconnection are less likely to occur. Even if a short circuit and a disconnection occur, the voltage of the communication line is relatively low. Therefore, sparks or the like are less likely to be generated as compared to the case of the above-described wiring line, and there is less danger. In the configuration of the present invention, the length of the wiring line which is thin and high-voltage is made short, and wiring is carried out (the wiring line is routed) such that communication with the control device 40 is established by the thick and low-voltage communication line. This configuration enables a short circuit and a disconnection of the wiring line to be less likely to occur, and the danger caused when the short circuit and the disconnection occur can be reduced. In the communication line, since a plurality of pieces of information can be transmitted by two lines, the number of wiring lines extended to the control device 40 can be reduced. A place where a wiring line through which a high voltage flows may be limited to only between the electrode unit 100 and the balancer circuit 20, so that a voltage between the balancer circuit 20 and the controller 30 can be decreased. Therefore, safety can be enhanced. Since the voltage measurement is performed near the electrode unit 100 by means of the balancer circuit 20, not only the voltage signal but also the abnormality signal (abnormality flag) can be promptly sent to the control device 40 via the controller 30 if, for example, the voltage is excessively increased. Consequently, the control device 40 can issue a control instruction on the basis of the two pieces of information, which are the voltage signal and the abnormality signal (abnormality flag). By virtue of these features, reliability of the energy storage apparatus 1 can be improved.

In the energy storage apparatus 1, by arranging the plurality of connecting portions 113 on different sides of the current collector foil 110, it is possible to arrange the plurality of connecting portions 113 on the current collector foil 110 in relatively good balance. Thus, it is possible to suppress charge unevenness. Further, at the time of charge control, the control device 40 performs control of a charge end according to the voltage information of the balancer circuit 20 indicating the highest voltage. Consequently, even when there is occurrence of charge unevenness, the control device 40 can perform the control on the basis of a more appropriate voltage at the time of the charge control. At the time of discharge control, the control device 40 performs control of a discharge end according to the voltage information of the balancer circuit 20 indicating the lowest voltage. Consequently, even when there is occurrence of charge unevenness, the control device 40 can perform the control on the basis of a more appropriate voltage at the time of the discharge control. Therefore, even when there is occurrence of charge unevenness, the control device 40 can perform the control on the basis of a more appropriate voltage from among those of voltage information of a plurality of balancer circuits 20.

In the energy storage apparatus 1, by arranging the plurality of connecting portions 113 on the sides of the current collector foil 110 that are opposed to each other, the balancer circuits 20 can be connected at positions where a voltage difference due to the charge unevenness is large. Therefore, the charge unevenness can be further reduced or prevented.

In the energy storage apparatus 1, the connection portions of the plurality of connectors 400 which are the portions connected to the plurality of connecting portions 113 and the connection portions of the other connectors 400 which are the portions connected to the other connecting portions 113 are located at positions that do not overlap one another when viewed in the stacking direction. Consequently, even in a case where a width of the aforementioned connection portion of the connector 400 in the stacking direction or a width of the aforementioned connection portion of the other connector 400 in the stacking direction is large, it is possible to prevent those connection portions of the connector 400 and the other connector 400 from interfering with each other in the stacking direction.

If the control box 50 in which the balancer circuits 20 and the controller 30 are accommodated is located to be in contact with the electrode units 100, the electrode units 100 may be affected by discharge heat generation of the balancer circuit 20, which may cause a decrease in the life performance of the electrode units 100. In view of the above, a resin plate, a metal plate, a heat-insulating porous member (glass paper, a ceramic plate, or the like), or a space, etc., is arranged between the electrode unit 100 and the control box 50, so that the control box 50 is separated from the electrode unit 100. Consequently, it is possible to suppress thermal influence that a discharge of the balancer circuit 20 exerts on the electrode unit 100.

Although the energy storage apparatus 1 according to the present example embodiment has been described above, the present invention is not limited to the above-described example embodiment. The example embodiments disclosed herein are illustrative in all respects and not restrictive. The scope of the present invention includes all example embodiments, and modifications and combinations within the meaning and scope equivalent to the claims.

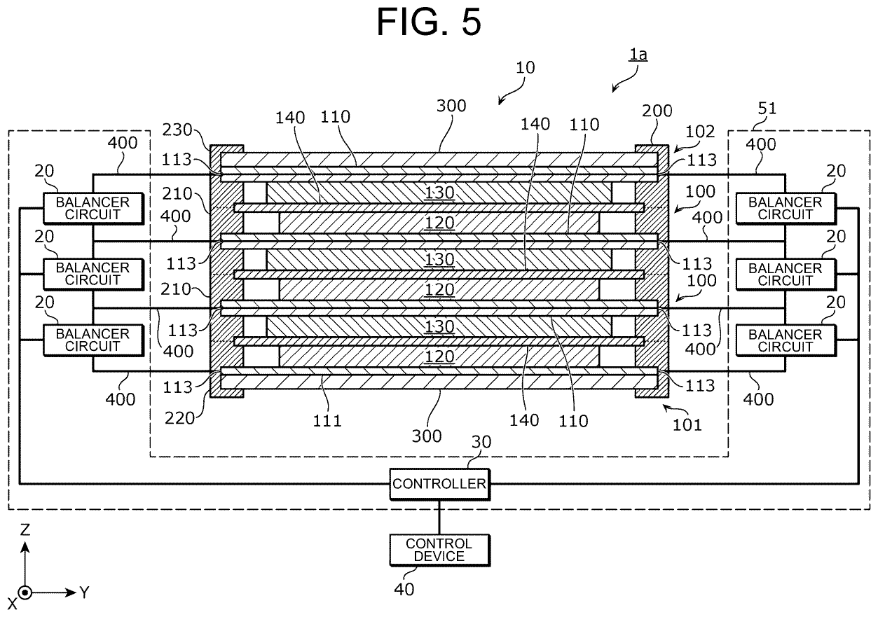

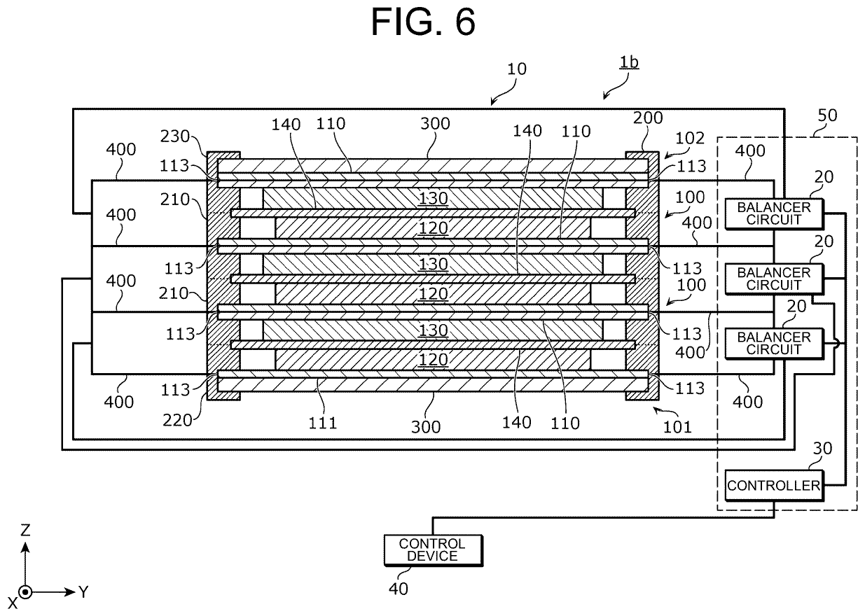

In the above-described example embodiment, the numbers of the balancer circuits 20 and the controllers 30 provided in the energy storage apparatus 1 are not limited to those described above. FIG. 5 is a schematic diagram illustrating a schematic configuration of an energy storage apparatus 1a according to Modification Example 1 of the present example embodiment. FIG. 6 is a schematic diagram illustrating a schematic configuration of an energy storage apparatus 1b according to Modification Example 2 of the present example embodiment. FIGS. 5 and 6 are views corresponding to FIG. 1.

As illustrated in FIG. 5, the energy storage apparatus 1a according to Modification Example 1 is provided with only one controller 30. The controller 30 is connected to all of the balancer circuits 20, and communicates with the control device 40 to exchange the voltage information of all of the balancer circuits 20 and the resistance discharge control information. All of the balancer circuits 20 and the controller 30 are accommodated in one control box 51. Other configurations of the present modification example are the same as those of the above-described example embodiment, and thus detailed description thereof will be omitted. As described above, the number of controllers 30 provided in the energy storage apparatus is not particularly limited. In the present modification example, depending on the positions where the balancer circuits 20 are arranged, not all of the balancer circuits 20 need to be accommodated in the control box 51. That is, some of the balancer circuits 20 may be accommodated in a control box different from the control box 51.

As illustrated in FIG. 6, in the energy storage apparatus 1b according to Modification Example 2, only one balancer circuit 20 is provided for one electrode unit 100. A plurality of connecting portions 113 provided on the current collector foil 110 of one electrode unit 100 are connected to one balancer circuit 20. One balancer circuit 20 acquires the voltage information and the like on the electrode unit 100 from the plurality of connecting portions 113 of one electrode unit 100, and sends (communicates) the voltage information and the like to the control device 40 via the controller 30. The aforementioned one balancer circuit 20 controls the state of charge (voltage) of the electrode unit 100 in response to an instruction from the control device 40 via the controller 30. For this reason, the energy storage apparatus 1b is provided with only one controller 30. All of the balancer circuits 20 and the controller 30 are accommodated in one control box 50. Other configurations of the present modification example are the same as those of the above-described example embodiment, and thus detailed description thereof will be omitted. As described above, the number of balancer circuits 20 provided in the energy storage apparatus is not particularly limited. In the present modification example, either a configuration in which only one balancer circuit 20 is provided for all of the electrode units 100 or a configuration in which only one balancer circuit 20 is provided for the unit group 10 as a whole may be used.

In the above-described example embodiment, a balancer circuit 20, which is connected only to the connecting portion 113 in the same electrode unit 100, may be provided.

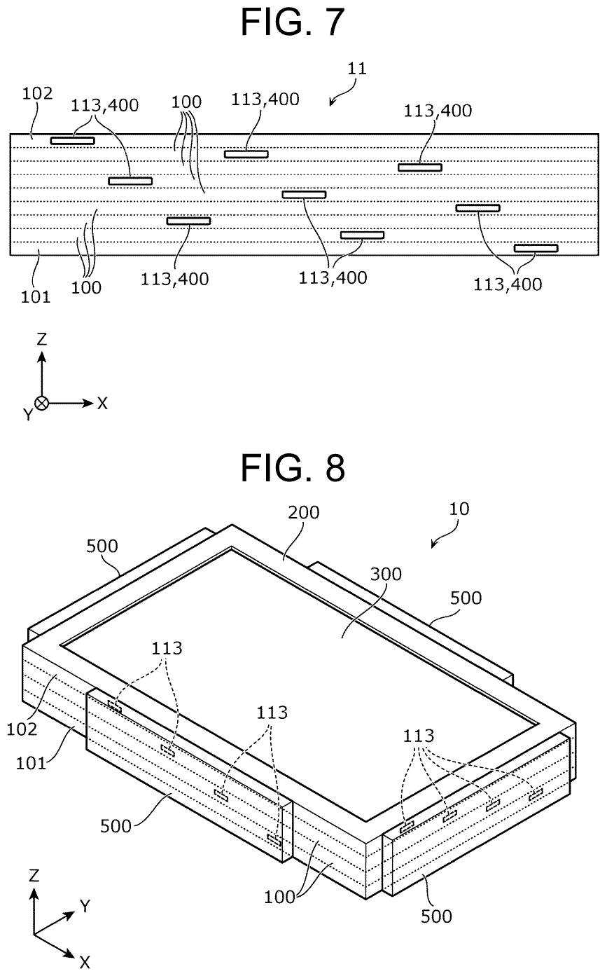

In the above-described example embodiment, the positions of arrangement of the connecting portion 113 and the connector 400 in the unit group 10 are not limited to those described above. FIG. 7 is a side view illustrating the positions of arrangement of the connecting portions 113 and the connectors 400 in a unit group 11 according to Modification Example 3 of the present example embodiment. FIG. 7 is a view of the unit group 11 and the connectors 400 as seen from the Y-axis negative direction side.

As illustrated in FIG. 7, the unit group 11 according to Modification Example 3 includes, for example, seven electrode units 100 between the end unit 101 and the end unit 102. In such a configuration, the connecting portion 113 of the end unit 102 is located at the farthest end in the X-axis negative direction. Among the electrode units 100, the connecting portion 113 of the electrode unit 100, which is the third-closest to an end portion in the Z-axis positive direction, is located at a separate position that is closer to the X-axis positive direction side than the connecting portion 113 of the end unit 102, and also closer to the Z-axis negative direction side than the connecting portion 113 of the end unit 102. Among the electrode units 100, the connecting portion 113 of the electrode unit 100, which is the sixth-closest to the end portion in the Z-axis positive direction, is located at a separate position that is closer to the X-axis positive direction side than the connecting portion 113 of the third electrode unit 100, and also closer to the Z-axis negative direction side than the connecting portion 113 of the third electrode unit 100. Similarly, the other connecting portions 113 are arranged side by side in the X-axis direction and at positions separated from each other in the Z-axis negative direction.

In this way, the connecting portions 113 which are located in the end unit 101, the end unit 102, and the seven electrode units 100 are all arranged at positions that do not overlap one another when viewed in the Z-axis direction. Therefore, the connection portions, which are portions connected to the connecting portions 113, of the connectors 400 connected to the connecting portions 113 in the end unit 101, the end unit 102, and the seven electrode units 100 are all arranged at positions that do not overlap one another when viewed in the Z-axis direction. One connector 400 and the other connector 400 are located at positions where the respective connection portions, which are the portions connected to the connecting portions 113, do not overlap one another when viewed in the Z-axis direction (stacking direction). Other configurations of the present modification example are the same as those of the above-described example embodiment, and thus detailed description thereof will be omitted. In this way, a distance between such connection portions of the adjacently arranged connectors 400 in the Z-axis direction can be increased. Therefore, even in a case where a width of the connection portion of the connector 400 is large in the Z-axis direction, the connection portions of the connectors 400 can be prevented from coming into contact with each other.

In the above-described example embodiment, the plurality of connecting portions 113 in the unit group 10 may be unified by a connector. FIG. 8 is a perspective view illustrating a configuration in which a connector 500 is arranged for the connecting portions 113 of the unit group 10 according to Modification Example 4 of the present example embodiment. FIG. 8 is a view corresponding to FIG. 2.

As illustrated in FIG. 8, an energy storage apparatus according to Modification Example 4 further includes the connector 500 which is connected to at least one connecting portion 113 of a plurality of connecting portions 113 provided in one electrode unit 100, and the other connecting portions 113 provided in the other electrode units 100. A plurality of connecting portions 113 provided in different electrode units 100 are connected to one connector 500. In the present example embodiment, four connectors 500 are located on four side surfaces of the unit group 10. Although the connecting portion 113 and the connector 500 are joined to each other by a wiring line or the like, the form of connection of the connecting portion 113 and the connector 500 is not particularly limited. The connector 500 may be detachably connected to the unit group 10 or may be fixed to the unit group 10.

Specifically, a plurality of connecting portions 113 located at an end portion in the X-axis positive direction among the connecting portions 113 provided in the unit group 10 are connected to one connector 500 located on the X-axis-positive-direction side surface of the unit group 10. A plurality of connecting portions 113 located at an end portion in the Y-axis negative direction are connected to one connector 500 located on the Y-axis-negative-direction side surface of the unit group 10. The same applies to the plurality of connecting portions 113 located at an X-axis-negative-direction end portion of the unit group 10, and the plurality of connecting portions 113 located at a Y-axis-positive-direction end portion of the same. Other configurations of the present modification example are the same as those of the above-described example embodiment, and thus detailed description thereof will be omitted. As described above, since the energy storage apparatus is provided with the connector 500 that is connected to the connecting portion 113 and the other connecting portion 113, the balancer circuit 20 can be easily connected to the connecting portion 113 and the other connecting portion 113 by way of a simple operation which is to connect the balancer circuit 20 to the connector 500.

In the above-described example embodiment, it has been indicated that the current collector foil 110 of the electrode unit 100 has a quadrangular shape in a plan view, and four connecting portions 113 are arranged on the four edges of the current collector foil 110, respectively. However, the arrangement is not limited to the above. In a case where the current collector foil 110 has a polygonal shape other than a quadrangular shape in a plan view, the plurality of connecting portions 113 may be located on different edges of the current collector foil 110 or the edges that are opposed to each other of the current collector foil 110. When the current collector foil 110 does not have a polygonal shape, such as being circular, elliptical, or oval in a plan view, it is sufficient if each of the plurality of connecting portions 113 is located at a position which is at an end portion of the current collector foil 110 on the XY plane and at which the connecting portion 113 does not come into contact with the other connecting portions 113. It suffices that each of the plurality of connecting portions 113 is located in a direction different from that of the other connecting portions 113 when viewed from the center of the current collector foil 110 in the XY plane, and the plurality of connecting portions 113 may be located on different sides of the current collector foil 110 or on the sides opposed to each other of the same, for example. In the above-described example embodiment, it has been indicated that the plurality of connecting portions 113 are arranged on the sides (edges) of the current collector foil 110 that are opposed to each other. However, the arrangement is not limited to the above. Two connecting portions 113 may each be located on the adjacent edges of the current collector foil 110. It has been indicated that the plurality of connecting portions 113 are arranged on the different sides (edges) of the current collector foil 110. However, the arrangement is not limited to the above. The connecting portion 113 may be located on only one edge of the current collector foil 110. The number of connecting portions 113 located on one edge of the current collector foil 110 is not particularly limited, and a plurality of connecting portions 113 may be located on one edge of the current collector foil 110. The position where the connecting portion 113 is located is also not particularly limited.

In the above-described example embodiment, it has been indicated that the connecting portion 113 is located on a surface of the current collector foil 110 in the Z-axis negative direction, and the connector 400 is connected to the above-mentioned surface of the current collector foil 110 in the Z-axis negative direction. However, the connection is not limited to the above. The connecting portion 113 may be located on a surface of the current collector foil 110 in the Z-axis positive direction, and the connector 400 may be connected to the above-mentioned surface of the current collector foil 110 in the Z-axis positive direction. The connecting portion 113 may be located between the positive electrode metal layer 111 and the negative electrode metal layer 112 of the current collector foil 110, and the connector 400 may be inserted between the positive electrode metal layer 111 and the negative electrode metal layer 112 to be connected to the connecting portion 113.

In the above-described example embodiment, it has been indicated that the connecting portion 113 is arranged within the sealing portion 210 at the end portion of the current collector foil 110. However, the arrangement is not limited to the above. The connecting portion 113 may be located at a position which is on the inner side relative to the sealing portion 210 of the current collector foil 110. In the case of a configuration in which the end portion of the current collector foil 110 protrudes toward the outer side in the X-axis direction and the Y-axis direction relative to the sealing portion 210, the connecting portion 113 may be located at a position which is on the outer side relative to the sealing portion 210 in the current collector foil 110.

In the above-described example embodiment, it has been indicated that the plurality of connecting portions 113 are located at positions not overlapping one another in a plan view. However, some of the connecting portions 113 may be located at positions overlapping one another in a plan view. Even if any two or more connecting portions 113 are located at positions overlapping one another in a plan view, it is sufficient if these two or more connecting portions 113 are separated from each other in the stacking direction to such an extent that the connectors 400, which are connected to these connecting portions 113, do not interfere with each other.

In the above-described example embodiment, it has been indicated that one controller 30 is provided for a plurality of balancer circuits 20. However, one controller 30 may be provided for one balancer circuit 20.

In the above-described example embodiment, it has been indicated that the balancer circuit 20, which is connected to the two electrode units 100, and the balancer circuit 20, which is connected to the electrode unit 100 and the end unit 102 (or the end unit 101), are two different balancer circuits 20. However, the balancer circuits 20 are not limited to the above. The aforementioned two balancer circuits 20 may be integrated as a single balancer circuit 20. As described above, the number of balancer circuits 20 is not particularly limited.

In the above-described example embodiment, it has been indicated that the balancer circuit 20, the controller 30, and the control device 40 are devices that are separate from each other. However, any two or all three of these devices may be integrated with each other. When the control device 40 is integrated with another device, the control device 40 is also accommodated in the control box 50.

In the above-described example embodiment, although it has been indicated that the controller 30 and the control device 40 are connected by a wiring line (in a wired manner) and communicate with each other, they may be wirelessly connected and communicate with each other. The same applies to the connection between the balancer circuit 20 and the controller 30.

In the above-described example embodiment, it has been indicated that the balancer circuit 20 and the controller 30 are accommodated in a single control box 50 and are arranged to be separated from the plurality of electrode units 100. However, the arrangement is not limited to the above. The balancer circuit 20 and the controller 30 may be accommodated in separate control boxes, or may not be accommodated in a control box. The control box 50 may be located in such a state that the control box 50 is in contact with the plurality of electrode units 100 (the unit group 10).

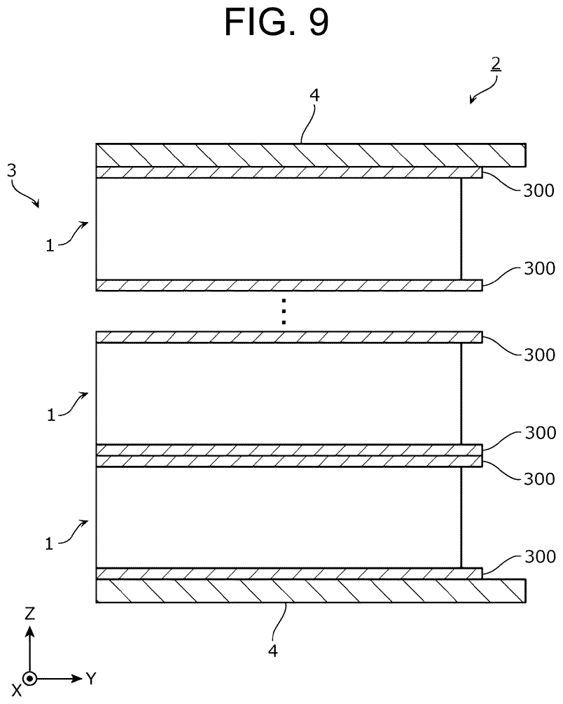

The energy storage apparatus 1 may be used in the energy storage pack 2 as illustrated in FIG. 9. FIG. 9 is a cross-sectional view illustrating a configuration of the energy storage pack 2. In FIG. 9, the internal configuration of the energy storage apparatus 1 is omitted from illustration. As illustrated in FIG. 9, the energy storage pack 2 includes an energy storage apparatus stacking body 3 in which a plurality of energy storage apparatuses 1 are stacked, and a conductive member 4. In this case, it is sufficient if the technique of the present invention is applied to at least one energy storage apparatus 1 included in the energy storage pack 2. Two adjacently arranged energy storage apparatuses 1 in the energy storage apparatus stacking body 3 are electrically connected to each other by contact or bonding (welding or the like). The conductive member 4 is made of a metal such as stainless steel, and the energy storage apparatus 1 which is located at an end portion in the stacking direction (the Z-axis direction) and the conductive member 4 are electrically connected to each other by contact or bonding (welding or the like). An adhesive may be used for the bonding. The plurality of energy storage apparatuses 1 in the energy storage apparatus stacking body 3 are connected in series, and charging and discharging are performed via the conductive member 4. The energy storage pack 2 may be restrained in the stacking direction (the Z-axis direction). In this case, a restraining member such as a screw, a resin band, or a metal band may be used. The energy storage apparatus stacking body 3 and the conductive member 4 may be accommodated in a metal case or a resin case.

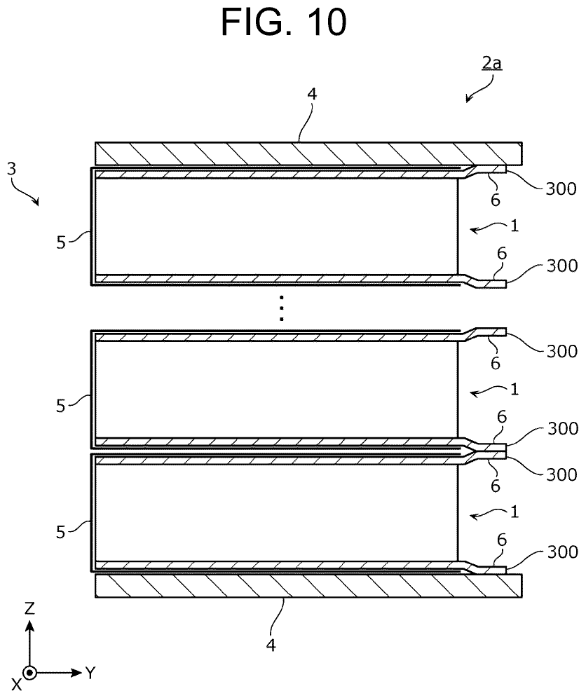

As another example of the energy storage pack 2, FIG. 10 shows a configuration in which each of the energy storage apparatuses 1 is accommodated in an outer package body 5. FIG. 10 is a cross-sectional view illustrating a configuration of an energy storage pack 2a. As illustrated in FIG. 10, the energy storage apparatus 1 of the present structure includes a connection portion 6 exposed from the outer package body 5. A laminate film or the like can be used as the outer package body 5. The connection portions 6 of the adjacently arranged energy storage apparatuses 1 are electrically connected to each other by contact or bonding (welding or the like). The connection portion 6 of the energy storage apparatus 1 which is located at an end portion in the stacking direction (the Z-axis direction) and the conductive member 4 are electrically connected to each other by contact or bonding (welding or the like). Since the other configurations are the same as those of the energy storage pack 2 described above, description thereof will be omitted.

Example embodiments constructed by arbitrarily combining elements included in the above-described example embodiments and the modification examples thereof are also included in the scope of the present invention.

Example embodiments of the present invention can be applied to energy storage apparatuses including a bipolar batteries or the like.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
a plurality of electrode units stacked in a stacking direction; wherein
each of the plurality of electrode units includes at least a current collector foil, a positive electrode active material layer on a first surface of the current collector foil, and a negative electrode active material layer on a second surface of the current collector foil, and a current collector foil included in one electrode unit of the plurality of electrode units includes a plurality of connecting portions electrically connected to a balancer circuit.

2. The energy storage apparatus according to claim 1,
further comprising:
the balancer circuit including both a voltage measurement function and a resistance discharge function for the each of the plurality of electrode units;
a first controller configured or programmed to use voltage information measured by the balancer circuit to acquire resistance discharge control information for the balancer circuit to perform resistance discharge; and
a second controller configured or programmed to communicate with the first controller to exchange the voltage information and the resistance discharge control information.

3. The energy storage apparatus according to claim 2, wherein
the plurality of connecting portions is located on different sides of the current collector foil; and
the first controller is configured or programmed to perform control of a charge end according to the voltage information of the balancer circuit indicating a highest voltage in the one electrode unit at a time of charge control.

4. The energy storage apparatus according to claim 2, wherein
the plurality of connecting portions is located on different sides of the current collector foil; and
the first controller is configured or programmed to control a discharge end according to the voltage information of the balancer circuit indicating a lowest voltage in the one electrode unit at a time of discharge control.

5. The energy storage apparatus according to claim 3, wherein the plurality of connecting portions is located on sides of the current collector foil that are opposed to each other.

6. The energy storage apparatus according to claim 2, wherein the balancer circuit and the second controller are accommodated in a single control box, and are separated from the plurality of electrode units.

7. The energy storage apparatus according to claim 1, wherein
an other current collector foil included in an other electrode unit of the plurality of electrode units includes an other connecting portion electrically connected to the balancer circuit;
the energy storage apparatus further comprises:
a plurality of connectors connected to the plurality of connecting portions; and
an other connector connected to the other connecting portion; and
a connection portion of each of the plurality of connectors connected to the each of the plurality of connecting portions and a connection portion of the other connector connected to the other connecting portion are located at positions that do not overlap when viewed in the stacking direction.

8. The energy storage apparatus according to claim 1, wherein
an other current collector foil included in an other electrode unit of the plurality of electrode units includes an other connecting portion electrically connected to the balancer circuit; and
the energy storage apparatus further comprises a connector connected to at least one connecting portion of the plurality of connecting portions and the other connecting portion.
